(19) United States
(12) Patent Application Publication
(10) Pub. No.: US 2013/0276097 A1
(43) Pub. Date: Oct. 17, 2013

(54) USER AUTHENTICATION METHOD AND SYSTEM

(71) Applicant: HON HAI PRECISION INDUSTRY CO., LTD., New Taipei (TW)

(72) Inventor: CHIH-HANG CHAO, New Taipei (TW)

(73) Assignee: HON HAI PRECISION INDUSTRY CO., LTD., New Taipei (TW)

(21) Appl. No.: 13/727,525

(22) Filed: Dec. 26, 2012

(30) Foreign Application Priority Data
Apr. 13, 2012 (TW) 101113373

(51) Int. Cl. G06F 21/32

(52) U.S. Cl. CPC G06F 21/32
USPC 726/17

(57) ABSTRACT

An electronic device includes a display, a fingerprint sensor, and a processing unit. The display invites a user for a first input fingerprint. The fingerprint sensor receives the first input fingerprint of the user. If the first input fingerprint matches a first pre-stored fingerprint, the display invites the user to give a second input fingerprint. The fingerprint sensor receives the second input fingerprint. If the second input fingerprint matches a second pre-stored fingerprint, the processing unit allows the user to enter the electronic device. A user authentication method for the electronic device is also provided.

### REFERENCE TO RELATED APPLICATIONS

This application claims all benefits accruing under 35 U.S.C. §119 from Taiwan Patent Application No. 101113373, filed on Apr. 13, 2012 in the Taiwan Intellectual Property Office. The contents of the Taiwan Application are hereby incorporated by reference.

### BACKGROUND

1. Technical Field

The disclosure generally relates to a technology of user authentication, and particularly relates to a user authentication method and system based on fingerprint identification.

2. Description of Related Art

In many electronic devices, such as laptop computers and smartphones, fingerprint sensors have been introduced for security applications such as login authentication for the identification of users. Common authentication methods and systems based on fingerprint identification simply verify whether an input fingerprint matches a pre-stored fingerprint. However, those common authentication methods and systems cannot provide sufficiently high security for the electronic devices.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of an electronic device.

FIG. 2 is a flowchart showing one embodiment of a user authentication method for the electronic device of FIG. 1.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

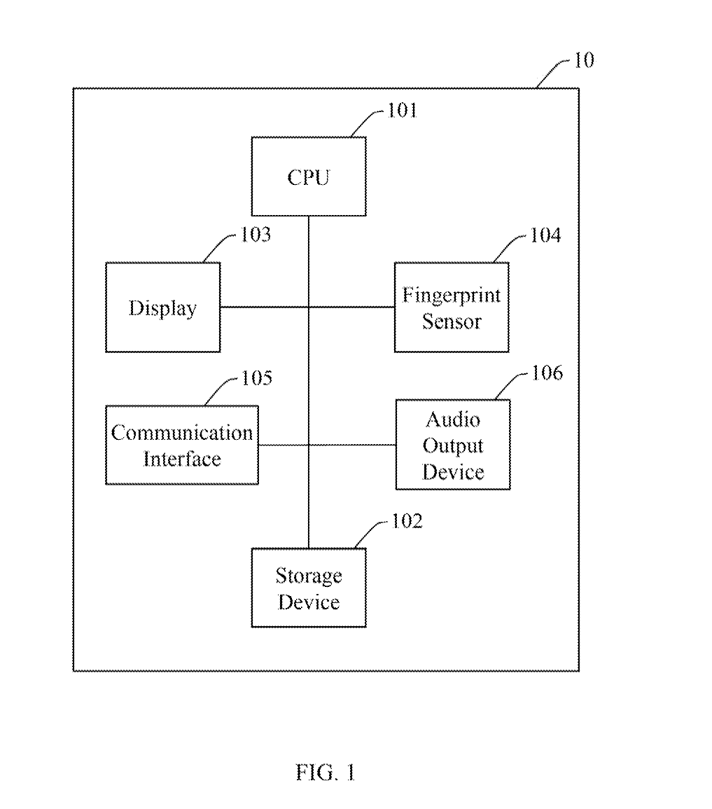

FIG. 1 shows one embodiment of an electronic device 10. The electronic device 10 includes a central processing unit (CPU) 101, a storage device 102, a display 103, a fingerprint sensor 104, a communication interface 105, and an audio output device 106. The electronic device 10 may be a smartphone, a personal digital assistant (PDA), a tablet computer, or the like.

The CPU 101 is operably coupled to the storage device 102, the display 103, and the fingerprint sensor 104. The CPU 101 may include one or more processors that provide the processing capability to execute the operating system, programs, user and application interfaces, and any other functions of the electronic device 10. The CPU 101 may include one or more microprocessors and/or related chip sets. For example, the CPU 101 may include “general purpose” microprocessors, a combination of general and special purpose microprocessors, instruction set processors, graphics processors, video processors, related chips sets, and/or special purpose microprocessors. The CPU 101 also may include on board memory for caching purposes.

Information, such as programs and/or instructions, used by the CPU 101 may be located within the storage device 102. The storage device 102 may store a variety of information and may be used for various purposes. For example, the storage device 102 may store firmware for the electronic device 10 (such as a basic input/output instruction or operating system instructions), various programs, applications, or routines executed on the electronic device 10, user interface functions, processor functions, and so forth. In addition, the storage device 102 may be used for buffering or caching during operation of the electronic device 10.

The storage device 102 may include any suitable manufacture that includes one or more tangible, computer-readable media. For example, the storage device 102 may include a volatile memory, such as random access memory (RAM), and/or as a non-volatile memory, such as read-only memory (ROM). The components may further include other forms of computer-readable media, such as non-volatile storage, for persistent storage of data and/or instructions. The non-volatile storage may include flash memory, a hard drive, or any other optical, magnetic, and/or solid-state storage media. The non-volatile storage may be used to store firmware, data files, software, wireless connection information, and any other suitable data.

The display 103 may provide a visual output interface between the electronic device 10 and a user. The visual output may include text, graphics, video, and any combination thereof. The display 103 may use LCD (liquid crystal display) technology, or LPD (light emitting polymer display) technology, although other display technologies may be used in other embodiments. In some embodiments, the display 103 may be a touch-sensitive display which also accepts input from the user based on haptic and/or tactile contact through a touch-sensitive surface.

The fingerprint sensor 104 may capture and recognize one or more fingerprints of the user. The one or more recognized fingerprints may be compared with one or more pre-stored fingerprints to determine whether the user is a specific user, such as an authorized user.

The communication interface 105 may provide connectivity channels for receiving and transmitting information and/or for connecting to other electronic devices. The communication interface 105 may represent, for example, a network interface card (NIC) or a network controller. The communication interface 105 may include a local area network (LAN) interface for connecting to a wired Ethernet-based network and/or a wireless LAN, such as an IEEE 802.11x wireless network.

The communication interface 105 also may include a wide area network (WAN) interface that permits connection to the Internet via a cellular data network, such as the Enhanced Data rates for GMS Evolution (EDGE) network or a 3G or 4G network. Further, the communication interface 105 may include a personal area network (PAN) interface for connecting to a BLUETOOTH® network, an IEE 802.15.4 (Zig-Bee) network, or an ultra-wideband network (UWB). The communication interface 105 may include any number and combination of network interfaces. The communication interface 105 can employ one or more protocols, such as the High-Speed Downlink Packet Access (HSDPA) protocol, for rapidly downloading data over a network.

The audio output device 106 may output music, speech, or any other sound. The audio output may be a loudspeaker or a headphone.

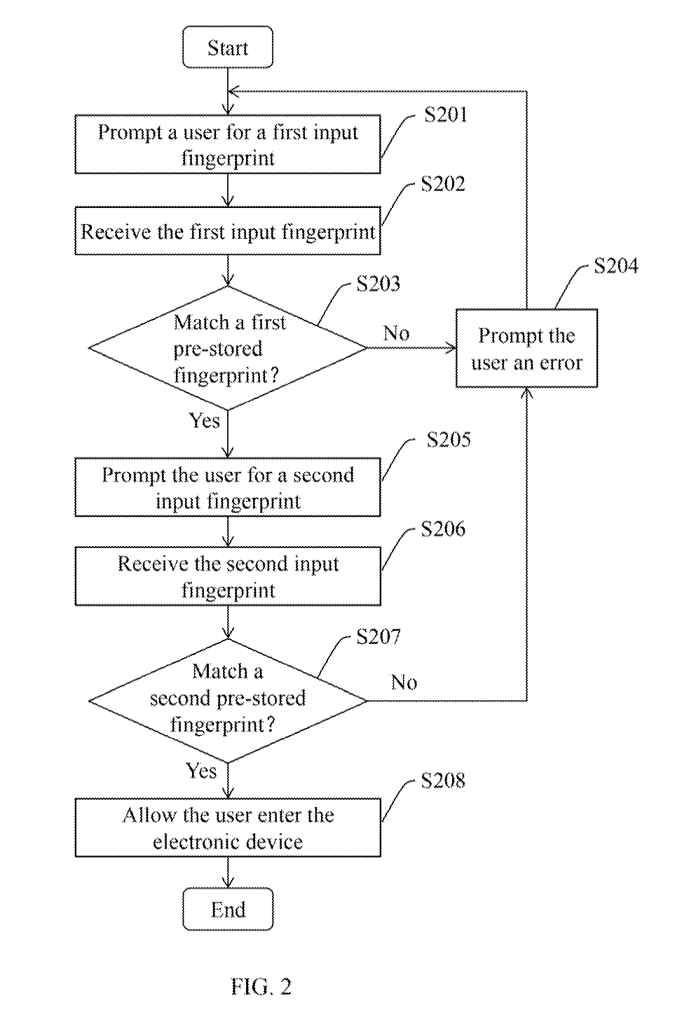

FIG. 2 is a flowchart showing one embodiment of a user authentication method for the electronic device 10. The method comprises the following steps.

In step S201, the display 103 displays a visual user interface to prompt the user for a first input fingerprint. In other embodiments, the audio output device 106 outputs an audible alert to prompt the user for the first input fingerprint.

In step S202, the fingerprint sensor 104 receives the first input fingerprint of the user.

In step S203, the CPU 101 determines whether the first input fingerprint matches a first pre-stored fingerprint. If the first input fingerprint matches the first pre-stored fingerprint, the flow goes to step S205; otherwise, the CPU 101 maintains the electronic device 10 in a user-interface locked state and the flow goes to step S204.

In step S204, the display 103 warns the user that the first input fingerprint is an error input. In other embodiments, the audio output device 106 prompts the user that the first input fingerprint is an error input. The flow then goes to step S201.

In step S205, the display 103 prompts the user for a second input fingerprint.

In step S206, the fingerprint sensor 104 receives the second input fingerprint of the user. In some embodiments, if the second input fingerprint has not been received within a predefined time period, the flow goes to step S204.

In step S207, the CPU 101 determines whether the second input fingerprint matches a second pre-stored fingerprint. If the second input fingerprint matches the second pre-stored fingerprint, the flow goes to step S208; otherwise, the CPU 101 maintains the electronic device 10 in a user-interface locked state and the flow goes to step S204. While the electronic device 10 is in the user-interface locked state, the electronic device 10 is prevented from performing a predefined set of actions in response to receiving any input that does not correspond to the first input fingerprint or the second input fingerprint. For example, when in the user-interface locked state, the user cannot log into a secured or private system of the electronic device, or obtain specific data from the electronic device.

In step S208, the CPU 101 allows the user to enter the electronic device 10. The CPU 101 transitions the electronic device 10 to a user-interface unlocked state in response to the determination that the second input fingerprint matches the second pre-stored fingerprint.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. An electronic device, comprising:
a display configured to prompt a user for a first input fingerprint;
a fingerprint sensor configured to receive the first input fingerprint of the user; and
a processing unit operably coupled to the display and the fingerprint sensor, the processing unit being configured to determine whether the first input fingerprint matches a first pre-stored fingerprint, wherein when the first input fingerprint matches the first pre-stored fingerprint, the display is further configured to prompt the user for a second input fingerprint, the fingerprint sensor is further configured to receive the second input fingerprint, and the processing unit is further configured to determine whether the second input fingerprint matches a second pre-stored fingerprint; when the second input fingerprint matches the second pre-stored fingerprint, the processing unit is further configured to allow the user to enter the electronic device.

2. The electronic device of claim 1, wherein when the first input fingerprint does not match the first pre-stored fingerprint, the display is further configured to prompt the user for the first input fingerprint again.

3. The electronic device of claim 1, wherein when the second input fingerprint does not match the second pre-stored fingerprint, the display is further configured to prompt the user for the first input fingerprint again.

4. The electronic device of claim 1, wherein when the fingerprint sensor has not received the second input fingerprint in a predefined time period, the display is further configured to prompt the user for the first input fingerprint again.

5. The electronic device of claim 1, wherein when the second input fingerprint matches the second pre-stored fingerprint, the processing unit is further configured to transition the electronic device to a user-interface unlocked state.

6. The electronic device of claim 1, wherein when the second input fingerprint does not match the second pre-stored fingerprint, the processing unit is further configured to maintain the electronic device in a user-interface locked state.

7. The electronic device of claim 6, wherein while the electronic device is in the user-interface locked state, the processing unit is configured to prevent the electronic device from performing a predefined set of actions in response to receiving any input that does not correspond to the first input fingerprint or the second input fingerprint.

8. An electronic device, comprising:
a fingerprint sensor;
a storage device;
at least one processor operably coupled to the fingerprint sensor and the storage device; and
one or more programs stored in the storage device and configured for execution by the at least one processor, the one or more programs comprising instructions to prompt a user for a first input fingerprint, to control the fingerprint sensor to receive the first input fingerprint of the user, to determine whether the first input fingerprint matches a first pre-stored fingerprint, to prompt the user for a second input fingerprint in response to a determination that the first input fingerprint matches the first pre-stored fingerprint, to control the fingerprint sensor to receive the second input fingerprint of the user, to determine whether the second input fingerprint matches a second pre-stored fingerprint, and to allow the user to enter the electronic device in response to a determination that the second input fingerprint matches the second pre-stored fingerprint.

9. The electronic device of claim 8, wherein the one or more programs further comprise instructions to prompt the user for the first input fingerprint in response to a determination that the first input fingerprint does not match the first pre-stored fingerprint.

10. The electronic device of claim 8, wherein the one or more programs further comprise instructions to prompt the user for the first input fingerprint in response to a determination that the second input fingerprint does not match the second pre-stored fingerprint.

11. The electronic device of claim 8, wherein the one or more programs further comprise instructions to prompt the user for the first input fingerprint again when the fingerprint sensor has not received the second input fingerprint in a predefined time period.

12. The electronic device of claim 8, wherein the one or more programs further comprise instructions to transition the electronic device to a user-interface unlocked state in response to a determination that the second input fingerprint matches the second pre-stored fingerprint.

13. The electronic device of claim 8, wherein the one or more programs further comprise instructions to maintain the electronic device in a user-interface locked state in response to a determination that the second input fingerprint does not match the second pre-stored fingerprint.

14. A user authentication method for an electronic device, the method comprising:
prompting a user for a first input fingerprint;
receiving the first input fingerprint of the user by a fingerprint sensor;
determining whether the first input fingerprint matches a first pre-stored fingerprint;
prompting the user for a second input fingerprint in response to a determination that the first input fingerprint matches the first pre-stored fingerprint;
receiving the second input fingerprint of the user by the fingerprint sensor;
determining whether the second input fingerprint matches a second pre-stored fingerprint; and
allowing the user to enter the electronic device in response to a determination that the second input fingerprint matches the second pre-stored fingerprint.

15. The method of claim 14, further comprising, prompting the user for the first input fingerprint again in response to a determination that the first input fingerprint does not match the first pre-stored fingerprint.

16. The method of claim 14, further comprising, prompting the user for the first input fingerprint again in response to a determination that the second input fingerprint does not match the second pre-stored fingerprint.

17. The method of claim 14, further comprising, prompting the user for the first input fingerprint again when the second input fingerprint has not been received in a predefined time period.

18. The method of claim 14, wherein the step of allowing the user to enter the electronic device comprises, transitioning the electronic device to a user-interface unlocked state.

19. The method of claim 14, further comprising, maintaining the electronic device in a user-interface locked state in response to a determination that the second input fingerprint does not match the second pre-stored fingerprint.

20. The method of claim 19, further comprising, while the electronic device is in user-interface locked state, preventing the electronic device from performing a predefined set of actions in response to receiving any input that does not correspond to the first input fingerprint or the second input fingerprint.
